(19) United States
(12) Patent Application Publication
(10) Pub. No.: US 2003/0212714 A1
(43) Pub. Date: Nov. 13, 2003

(54) Efficient deferred synchronization of objects

(75) Inventor: Erik Christian Larsen, Blacksburg, VA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 10/141,043

(22) Filed: May 8, 2002

(51) Int. Cl. G06F 17/30; G06F 12/00

(52) U.S. Cl. 707/201

(57) ABSTRACT

Objects are synchronized in a computer-implemented system. One or more operations are performed on one or more objects in a first group. One or more objects in a second group are then synchronized with the objects in the first group by collapsing the operations performed on the objects in the first group into singular operations performed on the objects in the second group.

### BACKGROUND OF THE INVENTION

1. Field of the Invention

The present invention relates generally to computer-assisted graphics programs, and in particular, to a method for the efficient deferred synchronization of objects therein.

2. Description of the Related Art

Many graphics programs generate and manipulate objects and their corresponding groups. Generally, the operations that can be performed on the objects include add, modify, and delete operations, wherein the add operation adds a new object to a group, the modify operation modifies properties of an object already residing in a group, and the delete operation removes an object from a group.

In certain situations, groups of objects must be maintained identically (synchronized). Ideally, when an add, modify, or delete operation occurs on a first group A, the same operation should be mimicked on a second group B. However, due to constraints on operations for the first group A, mimicking operations to be performed on the second group B may have to be deferred to certain time intervals. On the other hand, between those time intervals, multiple operations can occur on the first group A. Therefore, the operations occurring on the first group A have to be saved, so that those deferred operations can later be executed on the second group B.

One solution would appear to be to save all the operations that have occurred on the first group A since the last synchronization, and then execute all of those saved operations on the second group B at the next available time interval. However, there is another constraint that makes this less than ideal. When mimicking an add or modify operation on the second group B, the first group A must by queried for the current, complete state of that object. However, if the first group A has received a delete operation for that object sometime after an add or modify operation, but before the second group B has been synchronized, the first group A will no longer contain that object. A query of the first group A for that object will fail.

Another solution to this could be to simply ignore these expired operations. However, if there are a large number of these expired operations, then time is wasted querying the first group A. Further, if multiple modify operations on a single object have occurred before synchronization (a common scenario), time is wasted repeatedly querying the first group A and updating the second group B.

There is a need in the art for minimizing the group of saved operations so that the only operations performed on the second group B ate those that are essential to synchronizing the second group B with the first group A.

Another solution then would be to search the group of deferred operations and attempt to collapse multiple operations into one operation. For example, all consecutive modify operations for a single object can be collapsed into a single modify operation for that object. However, it is expensive in terms of processing time and storage space to perform the search and build a minimized group of deferred operations.

Consequently, there is a need in the art for a synchronization technique that only requires one operation be saved for each object, regardless of how many deferred operations occur on that object.

### SUMMARY OF THE INVENTION

To address the requirements described above, the present invention discloses a method for synchronizing objects in a computer-implemented system. One or more operations are performed on one or more objects in a first group. One or more objects in a second group are then synchronized with the objects in the first group by collapsing the multiple operations performed on each object in the first group into a singular operation performed on each object in the second group.

### BRIEF DESCRIPTION OF THE DRAWINGS

Referring now to the drawings in which like reference numbers represent corresponding parts throughout:

FIG. 1 is an exemplary hardware and software environment used to implement the preferred embodiment of the invention;

FIG. 2 is a block diagram that illustrates the components of the graphics program according to the preferred embodiment of the present invention;

FIGS. 3A and 3B are block diagrams that illustrate groups of objects maintained by a three-dimensional database according to the preferred embodiment of the present invention;

FIG. 4 illustrates a state machine for collapsing operations according to the preferred embodiment of the present invention; and

FIG. 5 is a flowchart that illustrates the logic of the graphics program according to the preferred embodiment of the present invention.

### DETAILED DESCRIPTION OF THE PREFERRED EMBODIMENTS

In the following description, reference is made to the accompanying drawings which form a part hereof, and which is shown, by way of illustration, an embodiment of the present invention. It is understood that other embodiments may be utilized and structural changes may be made without departing from the scope of the present invention.

Overview

The present invention provides an efficient method for performing deferred synchronization of two or more groups of objects. In the preferred embodiment, an arbitrary series of operations on a single object can be collapsed into a singular operation, thereby avoiding storage and processing of the arbitrary series of deferred operations.

Every time an operation for a particular object occurs for a first group A, the last operation for that object is combined with the next operation, according to predefined rules, to obtain a resulting operation required for a second group B. This resulting operation is then saved as the last operation. When the next operation is performed on this object, it is again combined with the last operation to obtain a resulting operation, which is then saved as the last operation. In this manner, only one operation on an object in the first group A needs to be saved and then executed for the second group B, regardless of how many deferred operations are performed on an object in the first group A.

Hardware and Software Environment

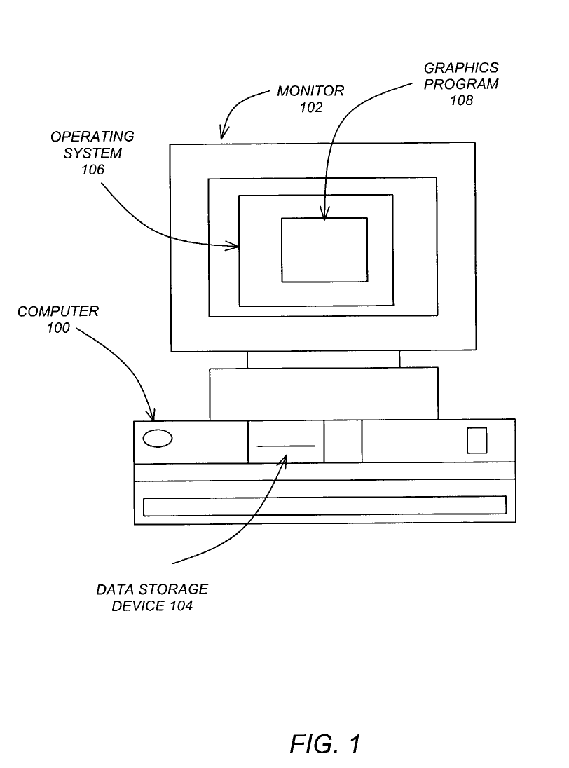

FIG. 1 is an exemplary hardware and software environment used to implement the preferred embodiment of the invention. The preferred embodiment of the present invention is typically implemented using a computer 100, which generally includes, inter alia, a monitor 102, data storage devices 104, and other devices. Those skilled in the art will recognize that any combination of the above components, or any number of different components, peripherals, and other devices, may be used with the computer 100.

The computer 100 usually operates under the control of an operating system 106, which is represented by a window displayed on the monitor 102. The preferred embodiment of the present invention is implemented by a computer-implemented graphics program 108, which is also represented by a window displayed on the monitor 102, that operates under the control of the operating system 106.

Generally, the operating system 106 and graphics program 108 comprise logic and/or data embodied in or readable from a device, media, or carrier, e.g., one or more fixed and/or removable data storage devices 104 connected directly or indirectly to the computer 100, one or more remote devices coupled to the computer 100 via data communications devices, etc.

Those skilled in the art will recognize that the exemplary environment illustrated in FIG. 1 is not intended to limit the present invention. Indeed, those skilled in the art will recognize that other alternative environments may be used without departing from the scope of the present invention.

Computer-Implemented Graphics Program

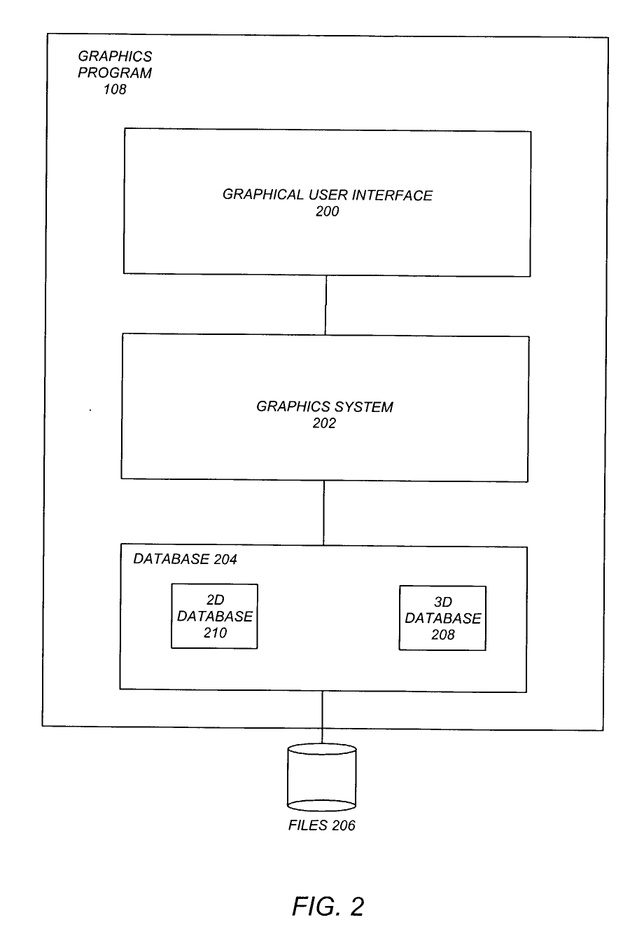

FIG. 2 is a block diagram that illustrates the components of the graphics program 108 according to the preferred embodiment of the present invention. There are three main components to the graphics program 108, including: a Graphical User Interface (GUI) 200, a Graphics System (GS) 202, and a Database (DB) 204 for storing objects in files 206.

The Graphical User Interface 200 displays information to the user and provides the functionality for the user's interaction with the graphics program 108. The Graphics System 202 processes the Database 204 and delivers the resulting graphics to an output device. The Database 204 is comprised of two separate types of databases: (1) a 3D database 208 known as the “world space” that stores 3D information; and (2) one or more 2D databases 210 known as the “virtual spaces” or “view ports” that stores 2D information derived from the 3D information.

Object Structure

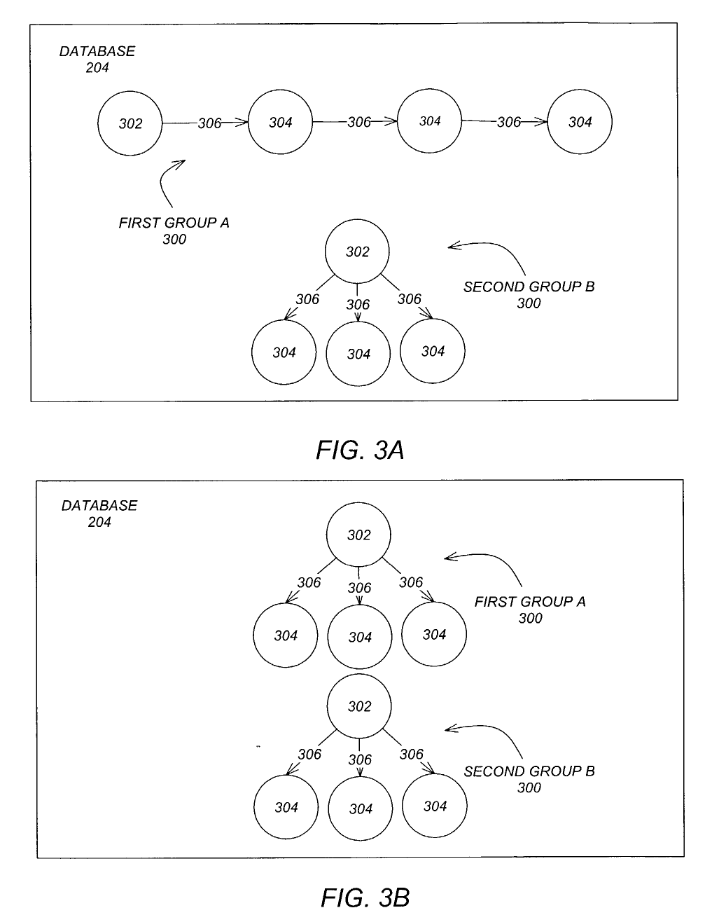

FIGS. 3A and 3B are block diagrams that illustrate groups of objects 300 maintained by the Database 204 according to the preferred embodiment of the present invention, wherein FIG. 3A illustrates two un-synchronized groups of objects 300 (first group A and second group B) being maintained in the same Database 204 and FIG. 3B illustrates two synchronized groups of objects 300 (first group A and second group B) being stored in the same Database 204. Each group of objects 300 includes a header node 302 and usually includes one or more nodes 304 connected by zero or more edges 306.

Operation of the Preferred Embodiment

The present invention describes an efficient method for deferred synchronization of multiple groups of objects. The purpose of the present invention is to maintain identical groups of objects. The present invention requires that only one operation be saved for each object, regardless of how many deferred operations occur on that object.

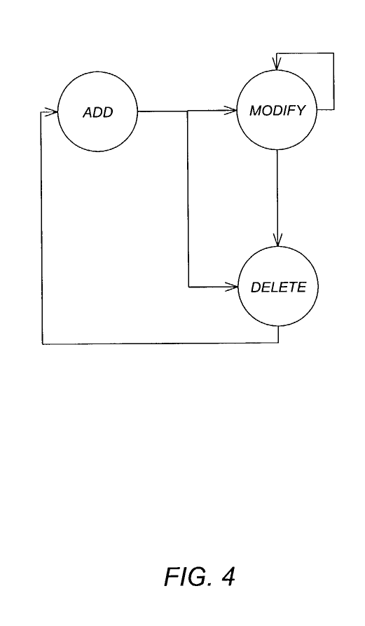

FIG. 4 illustrates a state machine for the valid sequence of operations that can occur on a single object according to the preferred embodiment of the present invention. The following describes the valid sequence of operations for the state machine.

The operations are selected from a group comprising Add, Modify, Delete and Null operations, wherein the Add operation adds a new object to a group, the Modify operation modifies properties of an object already residing in a group, the Delete operation removes an object from a group and the Null operation performs no actions. For any one object, only a Modify or Delete operation can follow an Add operation; only a Modify or Delete operation can follow a Modify operation; and only an Add operation can follow a Delete operation.

Enumerating these valid two-operation sequences, Table 1 lists the equivalent operation that have an identical effect on synchronizing a first group A and a second group B:

TABLE 1

| Last Operation on | Next Operation on | Resulting Operation on |
|---|---|---|
| first Group A | first Group A | second Group B |
| Add | Modify | Add |
| Add | Delete | Null |
| Modify | Modify | Modify |
| Modify | Delete | Delete |
| Delete | Add | Modify |

If invalid operations are to be included, then all possible combinations of two operations are enumerated in Table 2:

TABLE 2

| | | Next Operation | | | |
|---|---|---|---|---|---|
| | | Null | Add | Modify | Delete |
| Last | Null | Null | Add | Modify | Delete |
| Operation | Add | Add | Invalid | Add | Null |
| | Modify | Modify | Invalid | Modify | Delete |
| | Delete | Delete | Modi | Invalid | Invalid |

According to the preferred embodiment, every time an operation occurs on the first group A, the last operation is combined with the next operation using Table 2, to obtain the resulting operation required on the second group B. This resulting operation is then saved as the last operation. When the next operation is performed on this object, it is again combined with the last operation to obtain the resulting operation, which is then saved as the last operation. In this manner, only one operation is required to be saved and executed for an object in the second group B, regardless of how many deferred operations are performed on the object in the first group A.

Consequently, according to Tables 1 and 2, if the last operation is an Add operation, and the next operation is a Modify operation, then the resulting operation is an Add operation. If the last operation is an Add operation, and the next operation is a Delete operation, then the resulting operation is a Null operation. If the last operation is a Modify operation, and the next operation is a Modify operation, then the resulting operation is a Modify operation. If the last operation is a Modify operation, and the next operation is a Delete operation, then the resulting operation is a Delete operation. If the last operation is a Delete operation, and the next operation is an Add operation, then the resulting operation is a Modify operation.

Synchronization Logic

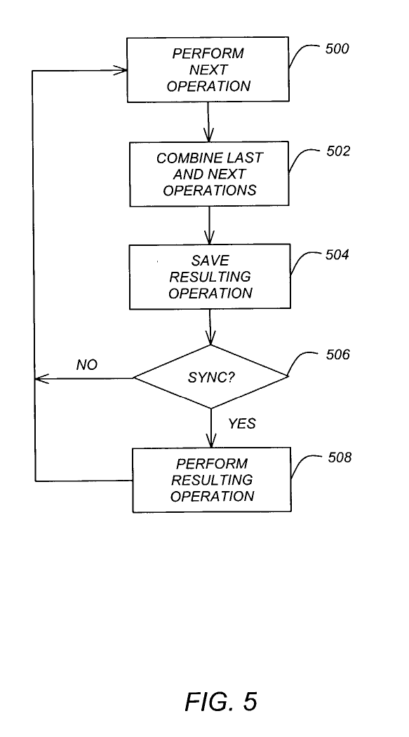

FIG. 5 is a flowchart that illustrates the logic of the graphics program 118 according to the preferred embodiment of the present invention. Those skilled in the art will recognize that this logic is provided for illustrative purposes only and that different logic may be used to accomplish the same results.

Block 500 represents the graphics program 118 performing an operation on one or more objects in a first group A. This operation is identified as a “next operation.”

Block 502 represents the graphics program 118 combining a last operation performed on the objects in the first group A with the next operation performed on the objects in the first group A to obtain a resulting operation. This combination is performed using the logic described in Tables 1 and 2, in order to collapse the last operation and the next operation on each object in the first group A into a singular operation, i.e., the resulting operation, that will be performed on the corresponding objects in the second group B, regardless of how many operations are performed on the objects in the first group A.

Block 504 represents the graphics program 118 saving the resulting operation as the “last operation.”

Block 506 is a decision block that represents the graphics program 118 determining whether to synchronize one or more objects in a second group B with the objects in the first group A. If so, control transfers to Block 508; otherwise, control transfers to Block 500 to repeat the steps of Blocks 500-506 or 500-508 for subsequent operations. Generally, this Block will defer the synchronization according to some specified criteria (for example, a user action, time interval, time period or number of operations).

Block 508 represents the graphics program 118 synchronizing the objects in the second group B by performing the resulting operation on one or more of the objects in the second group B. As a result of this Block, the synchronization maintains identical objects in the first group A and the second group B.

Thereafter, control transfers to Block 500 to repeat the steps of Blocks 500-506 or 500-508 for subsequent operations.

Conclusion

This concludes the description of the preferred embodiment of the invention. The following describes some alternative embodiments for accomplishing the present invention.

For example, any type of computer, such as a mainframe, minicomputer, work station or personal computer, could be used with the present invention. In addition, any program, function, or system for synchronizing objects could benefit from the present invention.

In summary, the present invention discloses a method for synchronizing objects in a computer-implemented system. One or more operations are performed on one or more objects in a first group A. One or more objects in a second group B are then synchronized with the objects in the first group A by collapsing the operations performed on the objects in the first group A into a singular operation performed on the objects in the second group B.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for synchronizing objects in a computer-implemented system, comprising:
(a) performing one or more operations on one or more objects in a first group; and
(b) synchronizing one or more objects in a second group with the objects in the first group by collapsing the operations performed on the objects in the first group into a singular operation performed on the objects in the second group.

2. The method of claim 1, wherein the operations performed on the objects in the first group are collapsed into the singular operation performed on the objects in the second group, regardless of how many of the operations are performed on the objects in the first group.

3. The method of claim 1, wherein the synchronizing step further comprises
(1) combining a last operation performed on the objects in the first group with a next operation performed on the objects in the first group to obtain a resulting operation;
(2) saving the resulting operation as the last operation; and
(3) performing the resulting operation on the objects in the second group.

4. The method of claim 3, further comprising repeating steps (1)-(2) for subsequent operations.

5. The method of claim 3, further comprising repeating steps (1)-(3) for subsequent operations.

6. The method of claim 3, wherein the operations are selected from a group comprising Add, Modify, Delete and Null operations, wherein the Add operation adds a new object to a group, the Modify operation modifies properties of an object already residing in a group, the Delete operation removes an object from a group and the Null operation performs no actions.

7. The method of claim 6, wherein only a Modify or Delete operation follows an Add operation; only a Modify or Delete operation follows a Modify operation; and only an Add operation follows a Delete operation.

8. The method of claim 7, wherein the last operation is an Add operation, the next operation is a Modify operation, and the resulting operation is an Add operation.

9. The method of claim 7, wherein the last operation is an Add operation, the next operation is a Delete operation, and the resulting operation is a Null operation.

10. The method of claim 7, wherein the last operation is a Modify operation, the next operation is a Modify operation, and the resulting operation is a Modify operation.

11. The method of claim 7, wherein the last operation is a Modify operation, the next operation is a Delete operation, and the resulting operation is a Delete operation.

12. The method of claim 7, wherein the last operation is a Delete operation, the next operation is an Add operation, and the resulting operation is a Modify operation.

13. The method of claim 1, wherein the synchronizing step is deferred.

14. The method of claim 1, wherein the synchronizing step maintains identical objects in the first and second groups.

15. An apparatus for synchronizing objects, comprising:
(a) a computer; and
(b) logic, performed by the computer, for:
(1) performing one or more operations on one or more objects in a first group; and
(2) synchronizing one or more objects in a second group with the objects in the first group by collapsing the operations performed on the objects in the first group into a singular operation performed on the objects in the second group.

16. The apparatus of claim 15, wherein the operations performed on the objects in the first group are collapsed into the singular operation performed on the objects in the second group, regardless of how many of the operations are performed on the objects in the first group.

17. The apparatus of claim 15, wherein the logic for synchronizing further comprises:
(i) logic for combining a last operation performed on the objects in the first group with a next operation performed on the objects in the first group to obtain a resulting operation;
(ii) logic for saving the resulting operation as the last operation; and
(iii) logic for performing the resulting operation on the objects in the second group.

18. The apparatus of claim 17, further comprising repeating the logic (i)-(ii) for subsequent operations.

19. The apparatus of claim 17, further comprising repeating the logic (i)-(iii) for subsequent operations.

20. The apparatus of claim 17, wherein the operations are selected from a group comprising Add, Modify, Delete and Null operations, wherein the Add operation adds a new object to a group, the Modify operation modifies properties of an object already residing in a group, the Delete operation removes an object from a group and the Null operation performs no actions.

21. The apparatus of claim 20, wherein only a Modify or Delete operation follows an Add operation; only a Modify or Delete operation follows a Modify operation; and only an Add operation follows a Delete operation.

22. The apparatus of claim 21, wherein the last operation is an Add operation, the next operation is a Modify operation, and the resulting operation is an Add operation.

23. The apparatus of claim 21, wherein the last operation is an Add operation, the next operation is a Delete operation, and the resulting operation is a Null operation.

24. The apparatus of claim 21, wherein the last operation is a Modify operation, the next operation is a Modify operation, and the resulting operation is a Modify operation.

25. The apparatus of claim 21, wherein the last operation is a Modify operation, the next operation is a Delete operation, and the resulting operation is a Delete operation.

26. The apparatus of claim 21, wherein the last operation is a Delete operation, the next operation is an Add operation, and the resulting operation is a Modify operation.

27. The apparatus of claim 15, wherein the logic for synchronizing is deferred.

28. The apparatus of claim 15, wherein the logic for synchronizing maintains identical objects in the first and second groups.

29. An article of manufacture embodying logic for synchronizing objects in a computer- implemented system, comprising:
(a) performing one or more operations on one or more objects in a first group; and
(b) synchronizing one or more objects in a second group with the objects in the first group by collapsing the operations performed on the objects in the first group into a singular operation performed on the objects in the second group.

30. The article of manufacture of claim 29, wherein the operations performed on the objects in the first group are collapsed into the singular operation performed on the objects in the second group, regardless of how many of the operations are performed on the objects in the first group.

31. The article of manufacture of claim 29, wherein the synchronizing step further comprises:
(1) combining a last operation performed on the objects in the first group with a next operation performed on the objects in the first group to obtain a resulting operation;
(2) saving the resulting operation as the last operation; and
(3) performing the resulting operation on the objects in the second group.

32. The article of manufacture of claim 31, further comprising repeating steps (1)-(2) for subsequent operations.

33. The article of manufacture of claim 31, further comprising repeating steps (1)-(3) for subsequent operations.

34. The article of manufacture of claim 31, wherein the operations are selected from a group comprising Add, Modify, Delete and Null operations, wherein the Add operation adds a new object to a group, the Modify operation modifies properties of an object already residing in a group, the Delete operation removes an object from a group and the Null operation performs no actions.

35. The article of manufacture of claim 34, wherein only a Modify or Delete operation follows an Add operation; only a Modify or Delete operation follows a Modify operation; and only an Add operation follows a Delete operation.

36. The article of manufacture of claim 35, wherein the last operation is an Add operation, the next operation is a Modify operation, and the resulting operation is an Add operation.

37. The article of manufacture of claim 35, wherein the last operation is an Add operation, the next operation is a Delete operation, and the resulting operation is a Null operation.

38. The article of manufacture of claim 35, wherein the last operation is a Modify operation, the next operation is a Modify operation, and the resulting operation is a Modify operation.

39. The article of manufacture of claim 35, wherein the last operation is a Modify operation, the next operation is a Delete operation, and the resulting operation is a Delete operation.

40. The article of manufacture of claim 35, wherein the last operation is a Delete operation, the next operation is an Add operation, and the resulting operation is a Modify operation.

41. The article of manufacture of claim 29, wherein the synchronizing step is deferred.

42. The article of manufacture of claim 29, wherein the synchronizing step maintains identical objects in the first and second groups.
